(19) United States
(12) Patent Application Publication
(10) Pub. No.: US 2005/0226092 A1
(43) Pub. Date: Oct. 13, 2005

(54) Method for the application of mortar to an application surface

(75) Inventors: Dietmar Zimmerlin, Blumberg (DE); Irmgard Zimmerlin, Donaueschingen (DE)

Correspondence Address: GUDRUN E. HUCKETT DRAUDT, LONSSTR. 53, WUPPERTAL, 42289, DE

(73) Assignee: INOTEC GmbH Transport-und Fordersysteme, Waldshut-Tiengen (DE)

(21) Appl. No.: 10/471,821

(22) PCT Filed: Mar. 20, 2002
(86) PCT No.: PCT/DE02/00997

§ 371 Date: Oct. 20, 2004

(30) Foreign Application Priority Data
Mar. 21, 2001 (DE) 101 13 785.0

(51) Int. Cl. B28C 5/46; B28C 7/00

(52) U.S. Cl. 366/6; 366/30

(57) ABSTRACT

In a method for applying a mortar mixture onto an application surface, a dry mortar starting mixture is prepared and conveyed by carrier air in a thin stream into a mixer arranged immediately upstream of a spray nozzle. The dry mortar starting mixture is mixed in the mixer with water to form a mortar-water mixture. The mortar-water mixture is moved in a dense stream to the spray nozzle. Compressed air is introduced into the spray nozzle and the mortar-water mixture is sprayed under the pressure of compressed air onto the application surface.

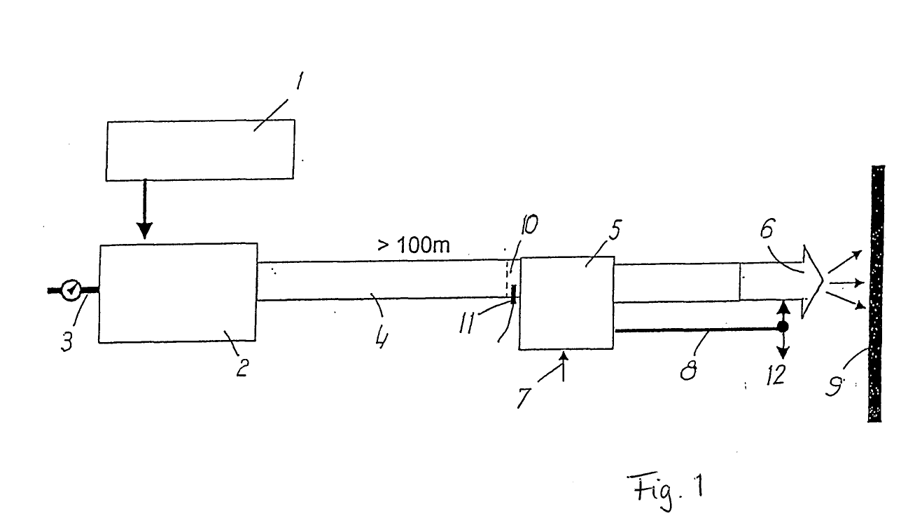

The invention relates to a method for applying a mortar mixture that is applied after its preparation in a positive mixer by a spray nozzle onto the application surface to be coated.

In a known method of this kind, the dry starting mixture is supplied from the positive mixer by means of a wet spraying machine to the connected spray nozzle and is applied by the spray nozzle onto the application surface with addition of carrier air. The wet mixture is transported by the wet spraying machine as a compact mortar column to the spray nozzle. This mortar column is torn apart in the spray nozzle by compressed air. In this way, the actual spray material is produced that is applied by means of material-dependent air pressure and a correspondingly dependent air volume onto the application surface.

This method has the following advantages: a uniform water/solids material value because the mixing ratio is predetermined and, accordingly, constant quality; low rebound of approximately 2 to 5%; and, as a result of the moisture contents of the starting material, a minimal dust development as well as continuous conveying of the mortar in the dense stream methods.

This wet spraying method is disadvantageous in that longer spray interruptions of more than approximately 30 minutes are not possible. The conveying distance is limited to 50 m so that a reduced action radius results, and the conveying height is limited to approximately 30 m. Hoses and machines must be cleaned after approximately 30 minute spray interruption as well as after termination of work, for example, in the evening. This causes a relatively high cleaning expenditure. Moreover, a recognizable material loss results from the mortar remaining within the hose.

In another known method, the so-called dry spraying method, the dry starting material is transported in an airstream through a conveying line to the spray nozzle. In the spray nozzle, with addition of water, wetting and mixing take place (thin stream conveying).

This method has the following advantages: the dry conveying action goes hand in hand with simple handling. The mixing process is not carried out until the spray nozzle is reached. In comparison to the wet spraying method, large conveying distances and conveying heights between 40 to 150 m can be achieved. The cleaning expenditure is comparatively minimal because only the mixing nozzle body must be cleaned. Moreover, extended spray interruptions are possible.

The dry spraying technique is disadvantageous for the fact that, as a result of the less effective wetting a greater rebound of 10 to 20% must be accepted. Because of this, a relatively high dust development results.

The object of the invention is to further develop the aforementioned method such that in a simple way the advantages of the wet spraying method can be combined with those of the dry spraying method without having to accept the aforementioned disadvantages of both methods.

The technical solution is characterized essentially in that the dry mortar starting mixture is conveyed in a mixer arranged immediately in front of the spray nozzle, is mixed therein with water, is conveyed in a dense stream to the spray nozzle, and is applied under pressure by compressed air introduced into it onto the application surface. The dense stream conveying action results in a sufficient wetting of the material.

In this way, the advantages of the wet spraying method as well as of the dry spraying method can be combined: since the mortar-water mixing process is not carried out until the area near the spray nozzle is reached, a simple handling of the material to be conveyed is provided as a result of conveying in the dry state, and conveying distances of far more than 100 m as well as great conveying heights can be achieved. Since on the way to the mixer dry mortar is being transported, longer spraying interruptions are possible very expediently. Also, at the site of use and in the surroundings, only minimal soiling results because of the minimal rebound of less than 5% and minimal dust development.

When at the time of shutting down initially the material supply is shut off, the mixing and conveying shaft is cleaned by the remaining air and water streams.

In the attached schematic illustration of the principle of the invention for applying a mortar mixture, reference numeral 1 indicates a silo for the starting material in the form of a dry mortar mixture that is supplied to a dry spraying machine 2 to be used in this connection. By means of a conduit 3 carrier air is supplied at a pressure of 1.5 to 3 bar to the spraying machine 2 from where the mortar mixture entrained in the carrier air is conveyed via a transport hose 4 that can have a length of more than 100 m in a steady thin stream to a mixer 5 that has a spray nozzle 6 arranged upstream thereof. In the drawing, the latter is illustrated schematically together with the mixer 5 as a unit that in practice is approximately 60 to 70 cm long. In this unit, i.e. in the part that is formed by the mixer 5, the mortar starting mixture is mixed with water that is supplied by the supply line 7 and reaches in the form of a mortar column, i.e., as a dense stream, the exit of the spray nozzle 6 where the material is separated from the dense stream by the pressure of the carrier air supplied via the conduit 8, is divided and sprayed in the form of particles onto the application surface 9 against which the nozzle 6 is directed.

The mixing and conveying members, for example, a mixing and conveying shaft, acting in the mixer 5 and not illustrated in detail in the drawing are exposed to the abrasive effect of the dry mortar that is supplied via the conveying hose 4 at a speed of approximately 90 km per hour. This effect can be reduced to a great extent by a control of the quantity of the mixture supplied to the mixer 5 as a function of the mortar quantity mixable in this area with water and conveyable away in a dense stream in such a way that, at the intake of the mixer 5, by means of a backing-up process a mortar layer 10 is formed that is only a few centimeters thick and in which the mixture particles supplied in the trailing thin stream are caught before they reach the mixing and conveying members of the mixer 5 and before they can develop their destructive effect.

Used in this connection is a sensor 11 for measuring the thickness of the mortar layer 10 forming at the intake side of the mixer 5, respectively, for controlling the speed of the mixer 5.

In connection with the backing-up process of the mortar layer 10, the also generated backed-up air is discharged from the transport hose end and is supplied by means of an air hose 8 extending parallel to the dense stream to the spray nozzle 6 in a controllable way.

Excess air is removed at the spray nozzle 6, preferably by means of a three-way valve 12.

As a drive for the mixing and conveying process of the mixer 5, carrier air or an electric motor is used preferably.

1.-6. (canceled)

7. A method for applying a mortar mixture onto an application surface, the method comprising the steps of:
preparing a dry mortar starting mixture;
conveying the dry mortar starting mixture by carrier air in a thin stream into a mixer arranged immediately upstream of a spray nozzle;
mixing the dry mortar starting mixture in the mixer with water to form a mortar-water mixture;
moving the mortar-water mixture in a dense stream to the spray nozzle; and
introducing compressed air into the spray nozzle and spraying the mortar-water mixture under the pressure of compressed air onto the application surface.

8. The method according to claim 7, further comprising the step of controlling a speed of the mixer such that at an intake side of the mixer, as a result of a backing-up process, a mortar layer having a thickness of a few centimeters is formed in which mixture particles supplied in the trailing thin stream are caught before they reach the mixing and conveying members of the mixer.

9. The method according to claim 8, further comprising the step of measuring with a sensor a thickness of the mortar layer forming at the intake side of the mixer and controlling the rotational speed of the mixing and conveying members of the mixer based on the thickness measured by the sensor.

10. The method according to claim 7, further comprising the step of branching off the carrier air conveying the dry mortar starting mixture to the mixer in a thin stream in an area of backed-up air generated at an end of a transport hose conveying the thin stream and supplying the branched-off carrier air, controlled by a three-way valve, via an air hose extending parallel to the dense stream to the spray nozzle.

11. The method according to claim 7, wherein the mixer has mixing and conveying members in the form of a mixing and conveying shaft.

12. The method according to claim 11, further comprising the step of controlling a speed of the mixing and conveying shaft.

13. The method according to claim 7, further comprising the step of driving the mixing and conveying member of the mixer by carrier air or an electric motor.
